(19) United States
(12) Patent Application Publication
(10) Pub. No.: US 2012/0293422 A1
(43) Pub. Date: Nov. 22, 2012

(54) INJURY DISCOVERY AND DOCUMENTATION

(75) Inventors: Timothy J. Collins, Homer Glen, IL (US); Esha Bhargava, Astoria, NY (US); Heidi A. Hattendoft, Chicago, IL (US)

(73) Assignee: MOTOROLA SOLUTIONS, INC., SCHAUMBURG, IL (US)

(21) Appl. No.: 13/112,461

(22) Filed: May 20, 2011

(51) Int. Cl. G06F 3/041

(52) U.S. Cl. 345/173

(57) ABSTRACT

A method and apparatus for injury discovery and documentation includes a graphical touchscreen interface of the device operable to show a body image to allow a user to select an area of an injury on the body image and selectable indicia to allow a user to select a relative level of pain due to the injury. The injury information can then be provided for diagnosis and treatment. The device can also include an audio interface operable to determine a native language of the patient, and converse with the patient to ask the patient a set of questions relating to the area of the injury that are pre-stored in a memory of the device.

### FIELD OF THE DISCLOSURE

The present invention relates generally to a documenting injuries and more particularly to an injury discovery and documentation, such as by an emergency medical technician.

### BACKGROUND

At an accident scene, emergency medical technicians (EMTs) have a need for an easy to use device to document a patient's injuries. However, a problem arises when the EMT does not speak the same language as the patient. As can be realized, there are several hundred languages spoken in the United States, which is also the case in many other countries around the world. In the United States, if an EMT does not understand the language of the patient, the EMT must treat that patient as being unconscious, which is obviously a less than satisfactory solution. Another problem occurs where some cultures do not allow voice communication between sexes.

What is needed is a technique that allows an injured patient which speaks a different language than the EMT, or will not speak to the EMT, to inform the EMT of what injury the patient has. It would also be of benefit if this injury could be documented using simple, easy to understand, and quick means.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a device, in accordance with the present invention.

FIG. 2 is a simplified illustration of a user interface of the device of FIG. 1, in accordance with the present invention.

FIG. 3 is a simplified block diagram of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a technique that allows an injured patient which speaks a different language than the EMT, or will not speak to the EMT, to inform the EMT of what injury the patient has. In particular, the present invention provides a communication device with an easy to understand user interface that can document the injury using simple, easy to understand, and quick instructions. Specifically, the present invention also provides a tablet device with a touchscreen graphical interface and an audio interface to provide interactive communications with a patient.

The figures show various assemblies adapted to support the inventive concepts of the embodiments of the present invention. Those skilled in the art will recognize that these figures do not depict all of the equipment necessary for the device and display to operate but only those components particularly relevant to the description of embodiments herein. For example, the device can include separate processors, controllers, communication interfaces, transceivers, memories, etc. In general, components such as processors, controllers, drivers, memories, and interfaces are well-known. For example, processing and controller units are known to comprise basic components such as, but not limited to, microprocessors, digital signal processors, microcontrollers, computers, drivers, memory devices, application-specific integrated circuits, and/or logic circuitry. Such devices are typically adapted to implement algorithms and/or protocols that have been expressed using high-level design languages or descriptions, expressed using computer instructions, expressed using messaging/signaling flow diagrams, and/or expressed using logic flow diagrams. Thus, given an algorithm or logic flow, those skilled in the art are aware of the many design and development techniques available to implement user equipment that performs the given logic. Therefore, the processors, controller, and drivers represent an apparatus that has been adapted, in accordance with the description herein, to implement various embodiments of the present invention.

Those skilled in the art are aware of the many design and development techniques available to configure a processor and a controller that implement a device with a touchscreen display. Therefore, the entities shown represent a system that has been adapted, in accordance with the description herein, to implement various embodiments of the present invention. Furthermore, those skilled in the art will recognize that aspects of the present invention may be implemented in and across various physical components and none are necessarily limited to single platform implementations. It is within the contemplation of the invention that the operating requirements of the present invention can be implemented in software, firmware and hardware, with the function being implemented in a processor or controller being merely options.

Devices that use touchscreen displays are known to refer to a wide variety of consumer electronic platforms such as cellular radiotelephones, user equipment, government, business or industrial equipment, subscriber stations, electronic tablets, access terminals, remote terminals, terminal equipment, cordless handsets, personal computers, smartphones, personal digital assistants, and the like, all referred to herein as devices. Each device comprises at least one processor that can be further coupled to a keypad, a speaker, a microphone, a display, a transceiver, and other features, as are known in the art. It should be recognized that each function can be a stand-alone module or can be incorporated into a host processor. The device can also include a display driver to operate the display to show information. It should be recognized that the display driver can be a stand-alone module or can be incorporated into the processor. Further, the device can also include memory. It should be recognized that the memory can be a stand-alone module or can be incorporated into any one of the processor, controller, or driver.

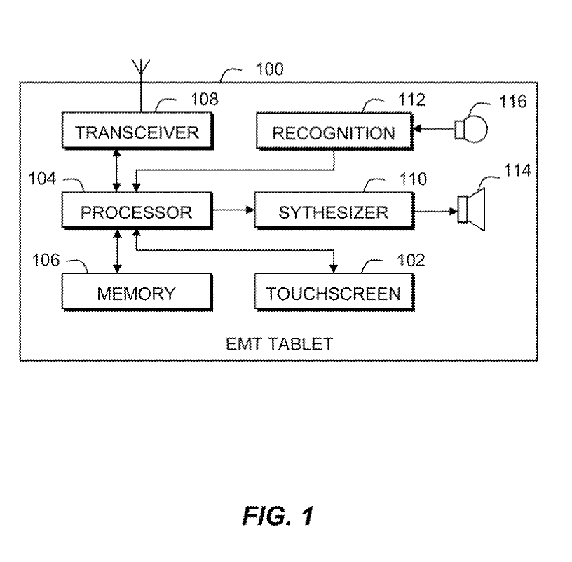

Referring to FIG. 1, an electronic communication tablet or device 100 for injury discovery and documentation is shown with a touchscreen graphical interface and audio interface, in accordance with the present invention. The device 100 can include a host processor 104, a touchscreen display 102 for providing a graphical user interface, a transceiver 108, a memory 106, and an audio interface including a microphone 116 with a voice recognition module 112 which could be incorporated into the processor and a speaker 114 driven by a voice synthesizer module 110 which could be incorporated into the processor. Any of the above elements can be incorporated into one module or a plurality of modules. The processor directs the touchscreen display to show interactive, functional information, such as icons, text, and/or graphical images to a user. The processor can also direct the audio interface to exchange voice information with a user. The graphical and audio interface can complement or supplement each other.

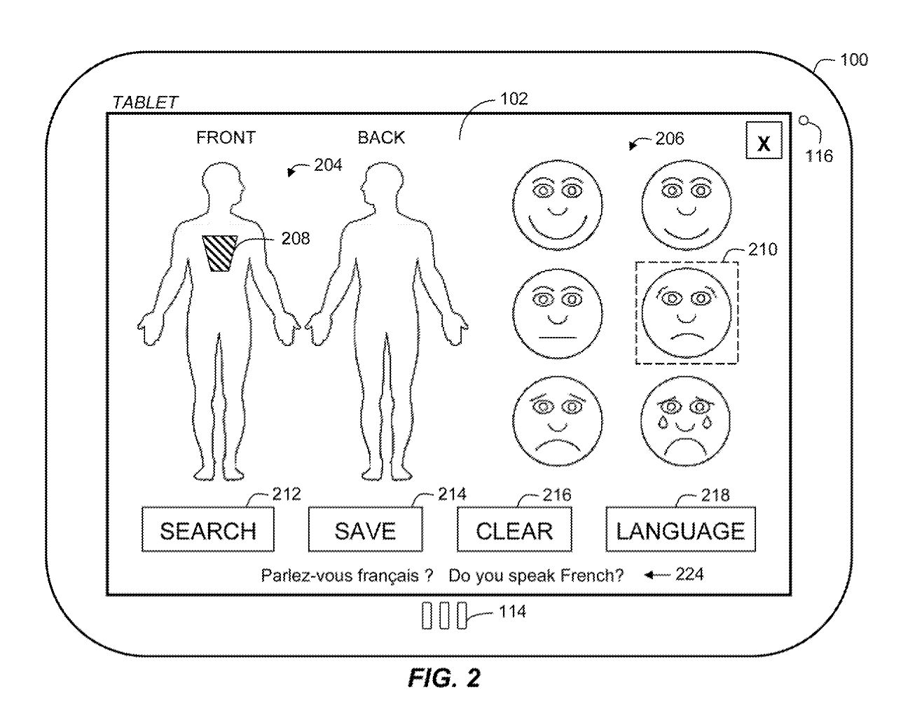

FIG. 2 illustrates an interface of the device 100, in accordance with the present invention. In particular, the present invention provides a touchscreen graphical interface 102 which allows a user (e.g. the patient or EMT) to select the area of the injury on a body image 204. In the example shown, a complementary front and back body image is presented. However, it can be that only one image is shown, zoomed images are shown upon selection, or addition top, bottom, or side images can be included. Additionally, the graphical interface 102 can provide a set of selectable pain indicia 206, where the patient can select an indicia that demonstrates the amount or relative level of pain they feel at the indicated injury site. For example, the indicia 206 can be the Wong-Baker FACES™ Pain Assessment Scale, as is known in the art. Alternatively or additionally, the indicia 206 can include numbers and/or pain-descriptive text such as: 0-5, or No hurt, Hurts little bit, Hurts little more, Hurts even more, Hurts whole lot, and Hurts worst, where the patient can select their level of pain. In the example shown, a patient can select the front chest area 208 of the body image 204 as the area of the pain, and then indicate that they are in moderate pain by selecting text (not shown) or an icon 210 (shown). The graphical interface can highlight the selected portions of the touchscreen using colors, text, outlines, and the like. The above approach can be accomplished without the patient ever talking with the EMT.

Of course, it would be better to have the EMT and patient converse to provide more detailed information. However, in those cases where the EMT and patient are unable to converse, the present invention provides an audio interface including a microphone 116 coupled to a voice recognition module (112 of FIG. 1) and a speaker coupled to a voice synthesizer (110 of FIG. 1). For example, if the patient is speaking, but the EMT does not recognize the native language of the patient, the EMT can press a “search” icon 212 on the touchscreen 102, wherein the microphone and voice recognition module can collect and provide a speech sample of the patient to the processor (104 of FIG. 1), which can compare the speech sample to known language samples pre-stored in the memory (106 of FIG. 1) in order to determine the native language of the patient. Alternatively, if the EMT recognizes (but does not understand) the patient's native language, the EMT can press a “language” icon 218 on the touchscreen 102, wherein the EMT can be presented a list of languages of pre-stored dialogue in the memory of the tablet, or the EMT can type in the recognized language using a keypad (not shown) of the tablet. The processor will direct the voice synthesizer to then ask the patient if the selected language is their native language. This instruction can be provided through the speaker 114, and can additionally be provided as text 224, with a translation that can be understood by the EMT, e.g. “Parlez-vous français? Do you speak French?” Responses from the patient can also be recognized and shown on the touchscreen as text 224, with a translation that can be understood by the EMT.

Preferably, the memory of the tablet can include a list of Yes/No, flowchart-type questions which are specific to the area of the injury selected by the patient or EMT (e.g. 208 of image 204). For example, if a patient touches the chest area of the body image, then the processor will direct the voice synthesizer to ask health questions specific to that area of body that have been pre-stored in the memory. These instructions can be provided through the speaker 114, and can additionally be provided as text 224, with a translation that can be understood by the EMT. For example, upon indicating a chest pain a set of questions can be present such as:

“La douleur dans votre coffre est-elle une douleur douce? Is the pain in your chest a mild pain?”

“La douleur dans votre coffre est-elle une douleur forte? Is the pain in your chest a strong pain?”

“Avez-vous le malaise dans votre dos ou cou de bras? Do you have discomfort in your arm back or neck?”

“Sentez-vous malade à vous l'estomac? Do you feel sick to you stomach?”

“Vous sentez-vous faible? Do you feel faint?”

The patient (or EMT) can verbally answer each question, recognized by the processor through the voice recognition module, or can press a “yes” or “no” icon (not shown) displayed on the touchscreen. The use of “yes” or “no” questions allows the patient to just nod their head to answer the question, and the EMT could enter their response by pressing the “yes” or “no” icon. Verbal answers from the patient (or EMT) can also be recognized and shown on the touchscreen as text 224, with a translation that can be understood by the EMT. Depending on the answers given, further sets of questions could be asked. In addition, depending on the answers given, further instructions can be given to the EMT via the graphical and/or audio interface.

Once the selections and responses have been made, the EMT can press a “save” icon 214 on the touchscreen 102. This action can save the documented injury information into the memory (106 of FIG. 1) for later recall, diagnosis and treatment by a doctor for example, and additionally transmit this information, to a hospital for example, using the transceiver (108 of FIG. 1). If an error has been made during the selections and responses, the EMT can press a “clear” icon 214 on the touchscreen 102 to clear the erroneous information.

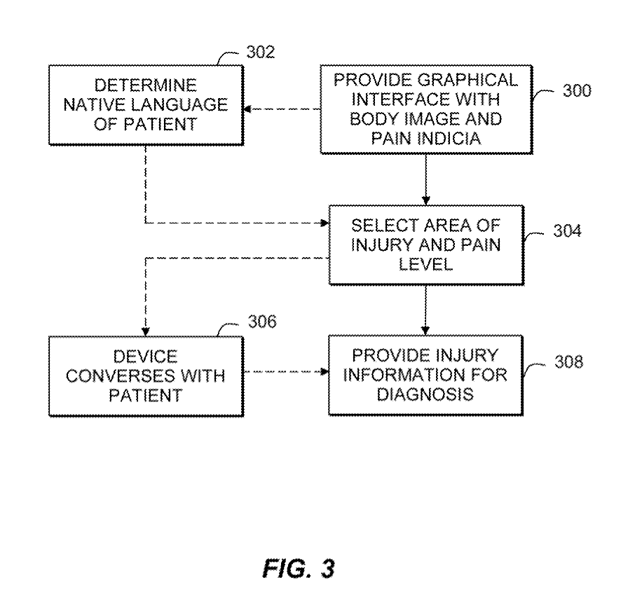

FIG. 3 illustrates a flowchart of a method for injury discovery and documentation, which includes a step 300 of providing a device with a graphical touchscreen interface showing a body image to allow a user to select an area of an injury on the body image. The graphical touchscreen interface can also include selectable pain indicia to allow a user to select a relative level of pain due to the injury. This step can also include providing an audio interface for the device to converse with a patient, particularly where the patient and EMT are unable to converse.

A next step 302 includes determining a native language of a patient. This can be accomplished by the audio interface recognizing the speech of a patient, and in particular by collecting a speech sample of the patient and comparing the speech sample to known language samples pre-stored in the device. This can also be accomplished by selection from a list of languages of pre-stored dialogue on the device by the user. In either case the processor will direct the voice synthesizer to then ask the patient if the selected language is their native language.

A next step 304 includes the user selecting an area of an injury on the body image on the touchscreen, which can include the relative level of pain due to the injury.

A next step 306 includes the audio interface of the device conversing with the patient. Conversing includes asking the patient a set of pre-stored questions relating to the area of the injury. This can be done in the native language of the patient. This can include showing text of the conversation, with a translation.

A next step 308 includes providing the injury information for diagnosis and treatment. The information can be stored in the device for later retrieval, or transmitted to a doctor or hospital.

Advantageously, the present invention provides a new interface designed to communicate with a patient who can not or will not communicate with an EMT. The interface is easy to understand and operate, and can be used without extensive training.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs for ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device for injury discovery and documentation, comprising:
a graphical touchscreen interface of the device operable to show a body image to allow a user to select an area of an injury on the body image and a relative level of pain;
a processor coupled to the graphical touchscreen interface; and
means coupled to the processor for providing the injury information for diagnosis and treatment.

2. The device of claim 1, wherein the graphical touchscreen interface is also operable to show selectable indicia to allow a user to select a relative level of pain.

3. The device of claim 1, further comprising an audio interface operable to converse with a patient.

4. The device of claim 3, wherein the processor and audio interface are operable to determine a native language of the patient.

5. The device of claim 4, wherein the processor and audio interface are operable to recognize the speech of the patient by collecting a speech sample of the patient and comparing the speech sample to known language samples pre-stored in a memory of the device.

6. The device of claim 3, wherein the processor and audio interface are operable to converse with the patient and ask the patient a set of questions relating to the area of the injury that are pre-stored in a memory of the device.

7. The device of claim 6, wherein the processor, audio interface, and graphical touchscreen interface are operable to show a text of the questions and a translation of the questions on the graphical touchscreen interface.

8. The device of claim 7, wherein the processor, audio interface, and graphical touchscreen interface are operable to show a text and a translation of the conversation on the graphical touchscreen interface.

9. A device for injury discovery and documentation where a patient and technician are unable to converse, comprising:
a graphical touchscreen interface of the device operable to show a body image to allow a user to select an area of an injury on the body image and selectable indicia to allow a user to select a relative level of pain due to the injury;
an audio interface operable to converse with a patient;
a processor coupled to the graphical and audio interfaces, wherein the processor and audio interface are operable to determine a native language of the patient and ask the patient a set of questions relating to the area of the injury that are pre-stored in a memory of the device; and
means coupled to the processor for providing the injury information for diagnosis and treatment.

10. The device of claim 9, wherein the processor, audio interface, and graphical touchscreen interface are operable to show a text of the questions and a translation of the questions on the graphical touchscreen interface.

11. A method for injury discovery and documentation, the method comprising the steps of:
providing a device with a graphical touchscreen interface showing a body image to allow a user to select an area of an injury on the body image;
selecting an area of an injury on the body image and a relative level of pain; and
providing the injury information for diagnosis and treatment.

12. The method of claim 11, wherein providing includes providing selectable indicia to allow a user to select a relative level of pain.

13. The method of claim 11, wherein providing includes providing an audio interface for the device to converse with a patient.

14. The method of claim 13, further comprising the step of determining a native language of the patient.

15. The method of claim 14, wherein determining includes recognizing the speech of the patient by collecting a speech sample of the patient and comparing the speech sample to known language samples pre-stored in the device.

16. The method of claim 13, further comprising the step of the audio interface of the device conversing with the patient and asking the patient a set of pre-stored questions relating to the area of the injury.

17. The method of claim 16, wherein the graphical touchscreen interface shows a text of the questions and a translation of the questions.

18. The method of claim 16, wherein the graphical touchscreen interface shows a text and a translation of the conversation.
